(19) United States
(12) Patent Application Publication
(10) Pub. No.: US 2019/0038978 A1
(43) Pub. Date: Feb. 7, 2019

(54) EXTENDABLE PLATFORMS FOR TRANSFER OF DATA BETWEEN PHYSICAL OBJECTS AND A VIRTUAL ENVIRONMENT

(71) Applicant: Intel Corporation, Santa Clara, CA (US)

(72) Inventor: Tomer Rider, Naahryia (IL)

(21) Appl. No.: 15/666,290

(22) Filed: Aug. 1, 2017

(51) Int. Cl. A63F 13/65; G06T 19/00; G06F 3/00; A63F 13/92

(52) U.S. Cl. CPC A63F 13/65; G06T 19/006; A63F 2300/69; A63F 13/92; A63F 2300/8082; G06F 3/002

(57) ABSTRACT

The present disclosure describes embodiments related to a portal apparatus for use with a virtual environment (VE) that may include a platform to receive a physical object that includes data associated with a representation of the physical object in the VE. A controller may be coupled with the platform to transfer all or part of the data between the physical object and the VE when the physical object is placed on the platform. A communication interface may be coupled with the controller to couple the portal apparatus to a host apparatus of the VE or to another portal apparatus that is directly or indirectly coupled to the host apparatus to propagate the data to the VE, directly to the host apparatus, or indirectly via one or more of the other enhanced portal apparatuses.

### FIELD

Embodiments of the present disclosure generally relate to the field of virtual reality and/or augmented reality. More specifically, embodiments of the present disclosure relate to devices and methods for physical toys-to-life (TTL) devices to interact with a virtual/augmented reality game or environment.

### BACKGROUND

Some virtual/augmented reality video games use TTL physical objects that allow a player to interact with and/or within a virtual/augmented reality game or environment. TTL devices, which may be referred to as toys, are static and are typically small, for example, 1 to 6 inches in height. These toys may be of various shapes that represent characters or objects found within a virtual reality game or environment. For example, one toy shape may be a human form that represents a player. Other toy shapes may include dragons, monsters, robots, war machines, and the like that respectively represent similar virtual-reality characters. Each toy includes digital data, which may be stored within the base of the toy, that includes information about the character or object the toy represents in the virtual reality game or environment.

A player typically places the toy onto a base platform to interact with the virtual/augmented reality game or environment. The base platform connects, for example, via a universal serial bus (USB), to a computing device that the player uses to interact with the virtual/augmented reality game or environment. The base platform includes communication hardware and/or software to read the digital data from the base of the toy and provides that data to the virtual reality game or environment via the computing device. For example, the toy may electronically store digital data about a player within a war-based virtual/augmented reality game. This digital data may include identification of the player, attributes of the player, state of gameplay, and/or location of the virtual character representing the player within the virtual/augmented reality game. Digital data may also represent awards, powers, player rank, player strength, weapons inventory, achievement levels, and/or special abilities of the player. This type of information will be available to the virtual/augmented reality game when the toy is placed on the base platform.

The base platform may use near field communications (NFC), Bluetooth™ Bluetooth low energy (BLE), radio frequency identification (RFID), or another communication process and/or protocol to determine if a toy is placed on the base platform and how to extract information stored as digital data about characteristics of a virtual representation of the toy. For example, by placing a toy representing a player onto a base platform, the computing device may load, also referred to as “transport,” the virtual representation of that player into the virtual/augmented reality game.

The digital data stored in the toy, while on the base platform, may be updated by the virtual/augmented reality game or environment via the computing device connected to the base platform. This allows the player to remove the toy from his base platform, take his toy to another location such as a friend's house, place the toy on the new base platform connected to his friend's computer, and have the player's current information that is stored in the toy uploaded to the virtual/augmented reality game so that the player may continue to play.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of multiple base platforms, in accordance with some embodiments.

FIG. 2 is a diagram of components within multiple base platforms, in accordance with some embodiments.

FIG. 3 illustrates features of an extended base platform, in accordance with some embodiments.

FIG. 4 illustrates features of an extended base platform used to articulate a host object, in accordance with some embodiments.

FIG. 5 illustrates a host figure with multiple articulations, in accordance with some embodiments.

FIG. 6 is a block diagram illustrating various components of an extended base platform or a host object, in accordance with some embodiments.

FIG. 7 is a block diagram that illustrates a process for providing a base platform for use with a virtual environment (VE), in accordance with some embodiments.

FIG. 8 is a diagram illustrating computer-readable media having instructions for practicing the above-described techniques, or for programming/causing systems and devices to perform the above-described techniques, in accordance with various embodiments.

FIG. 9 is a block diagram illustrating a process for implementing a physical object to be used on a portal in conjunction with a VE, in accordance with some embodiments.

FIG. 10 is a diagram illustrating computer-readable media having instructions for practicing the above-described techniques, or for programming/causing systems and devices to perform the above-described techniques, in accordance with various embodiments.

### DETAILED DESCRIPTION

Methods, apparatuses, and systems for providing enhanced base platforms and enhanced TTL toys, referred to herein as host objects, that work with enhanced base platforms are described herein. Enhanced base platforms may also be referred to as portals, and host objects may be referred to as figurines, toys, and/or gaming peripherals. In embodiments, enhanced base platforms and enhanced host objects may provide a richer experience for players interacting with a virtual/augmented reality game or environment that includes TTL support. Further, for ease of description and understanding, virtual or augmented reality will simply be referred to as virtual reality hereon forward. However, the term is not to be understood as limiting to virtual environment. The term, in general, is to be understood to cover virtual and/or augmented reality, unless the context unequivocally indicates one or the other.

In the following description, various aspects of the illustrative implementations are described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “including,” “having,” and the like, as used with respect to embodiments of the present disclosure, are synonymous.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

Various operations are described as multiple discrete operations in turn, in a manner that is most helpful in understanding the claimed subject matter. However, the order of description should not be construed as to imply that these operations are necessarily order dependent.

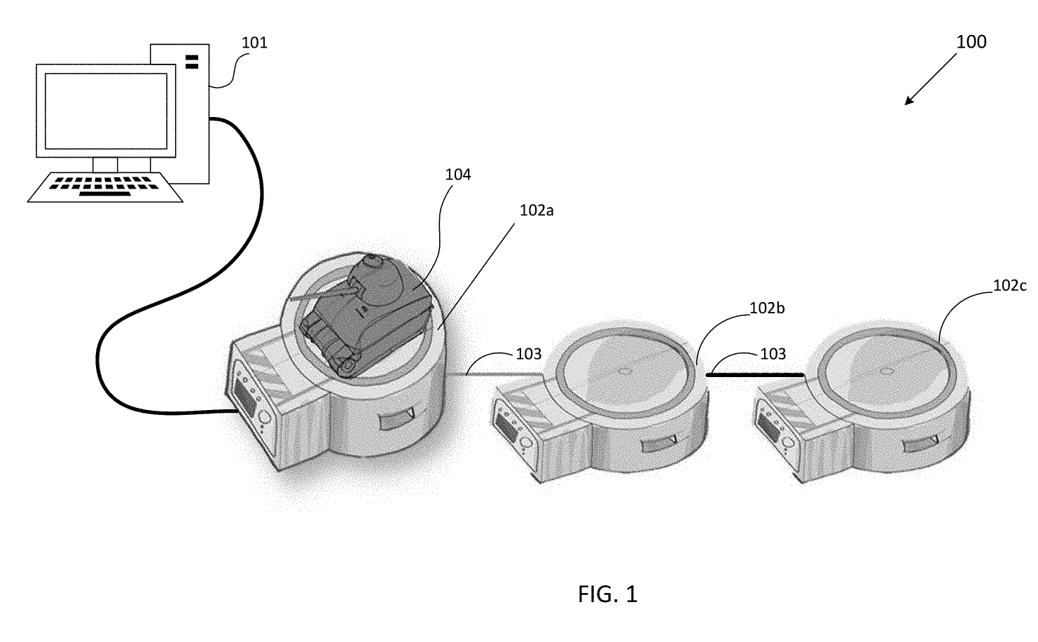

FIG. 1 illustrates an example of multiple base platforms, in accordance with some embodiments. Diagram 100 shows a first base platform 102a connected to two other base platforms 102b, 102c. In embodiments, the base platforms 102a-102c may be enhanced base platforms as described herein. The first base platform 102a may be connected to a computer or some other computing device 101 that itself may be connected to, operate part of, and/or otherwise interact with a virtual reality game or environment. In embodiments, the computing device 101 may be, for example, a personal computer, tablet, gaming platform such as Play Station™, Xbox™, Wii™ system, or other suitable device that is able to allow a player to interact with a virtual reality game or environment. In embodiments as described herein, base platforms 102a-102c, as well as host objects such as host object 104 that is placed on a base platform 102a, may be enhanced to provide a richer virtual reality game or environment experience for players.

In embodiments, multiple base platforms 102a-102c may be mapped to different areas within a virtual reality game or environment by computing device 101. In embodiments, multiple base platforms 102a-102c may be connected to each other or to the computing device 101 by wired 103 or wireless (not shown) connections in a serial, or daisy-chained, configuration or a mesh-network configuration as described below. In embodiments as discussed herein, enhancements to a base platform 102a may include an arbitrarily large surface sufficient to accommodate multiple popular host objects. Embodiments may include a mechanism to provide the ability to raise, lower, or tilt the base platforms 102a-102c. Embodiments may include mechanism or features to provide the ability to display, hide, or move non-host object features on the base platform 102a, for example, physical indicators that may move up and down with respect to a surface of a base platform, or scenery that may move or reposition itself on the base platform. In embodiments, one or more host objects 104 when placed on a base platform 102a-102c may be caused to raise, lower, rotate, or otherwise move from one location to another location on the base platform 102a. In embodiments, the base platforms 102a-102c may be equipped and/or configured to engage with a host object 104, for example, electrically, mechanically, electromagnetically, or in some other suitable fashion to cause articulated portions of the host object 104 to move. For example, a virtual object within the virtual reality game or environment that is mapped to the host object 104 may have an attribute that is changed to cause an articulated portion of the host object 104 to move. For example, if the virtual object is a flying dragon, the host object 104 related to the virtual object and shaped like a dragon may have wings that can be caused to flap in tandem. In another example, if the virtual object is feeding, the host object 104 may have jaws that can be caused to move and a belly that can be caused to grow in size in tandem.

With respect to host objects 104, in embodiments described herein, articulated portions of a host object 104 may be physically moved by a player when the host object 104 is either on or off of a base platform 102a-102c. In embodiments, the movement of articulated positions of the host object 104 may cause information stored as digital data within the host object to change to reflect the physical movement. In embodiments, a host object 104 may have a motor, a power source, and/or controller within the host object 104 that may cause articulated portions to be moved within the host object 104 itself. In embodiments, the articulated portions, or other portions of the host object 104 that may be used to move the articulated portions, may be made of an Electro Active Polymer (EAP) or other suitable polymer that may move and/or deform when exposed to an electric current or an electromagnetic field.

As shown in diagram 100, multiple base platforms 102a, 102b, 102c may be connected together to enhance a virtual reality gaming or environment experience. Connecting multiple base platforms to a computing device 101 may allow for an increase in the total area size on which host objects 104 may be placed. For example, a player may place multiple host objects, such as host object 104, onto multiple base platforms 102a, 102b, 102c. The information stored as digital data within the host objects may be communicated, directly or indirectly, to or from another base platform 102a, 102b, 102c, the computing device 101, and/or the virtual reality game or environment.

In embodiments, different base platforms 102a, 102b, 102c may map to different virtual locations in the virtual reality game or environment. For example, the first and second base platforms 102a, 102b may map to a virtual lobby area within a virtual reality game where the virtual characters may be waiting for initial play. The third base platform 102c may map to an advanced area on a different level within the virtual reality game, for example, within a virtual castle or a virtual base camp at the foot of a virtual mountain, where virtual characters mapped to host objects placed on the third base platform 102c will appear.

In embodiments, the multiple base platforms 102a, 102b, 102c may be connected in a variety of topologies. For example, the first base platform 102a may be a master base platform to be connected to a computer, the second base platform 102b may be a slave base platform connected to the master, and the third base platform 102c may be a slave base platform connected to the second base platform 102b in a daisy-chain fashion. In other embodiments, the base platforms 102a, 102b, 102c may be connected in a hierarchical fashion, a mesh-network fashion, or in some other suitable topology.

In embodiments, the base platforms 102a, 102b, 102c may serve as extensions to other base platforms, and may be branded and/or otherwise identified as associated with a particular manufacturer, virtual reality game or environment, or some other source identifier. In embodiments, the base platforms may be customized and/or branded by Original Equipment Manufacturers (OEMs).

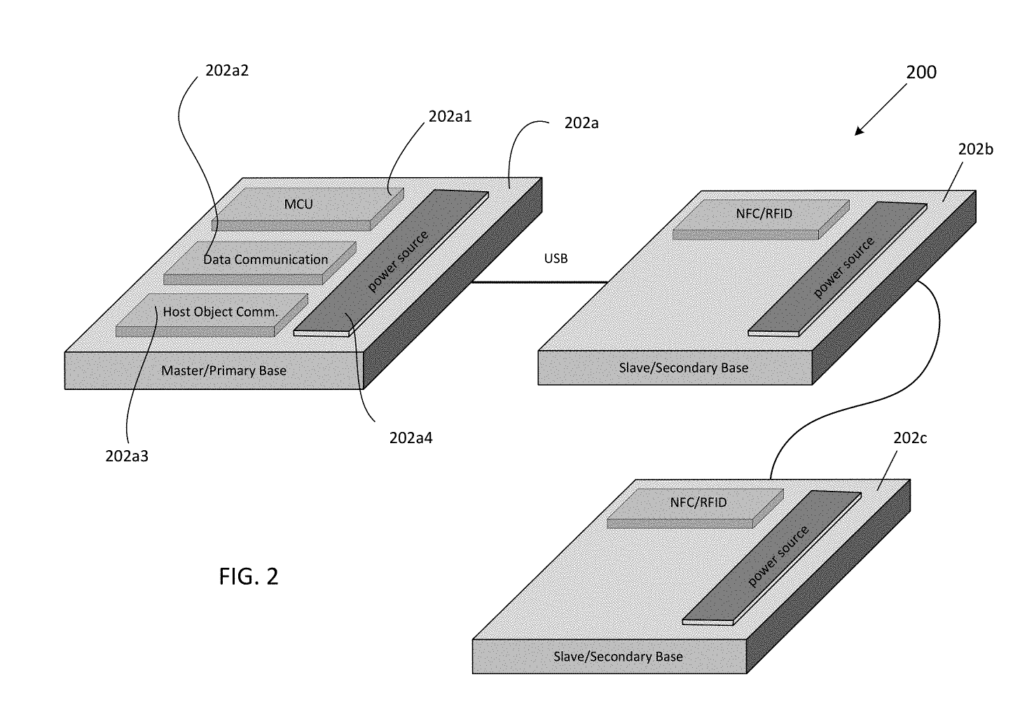

FIG. 2 is a diagram of components within multiple base platforms, in accordance with some embodiments. Diagram 200 shows three base platforms 202a, 202b, 202c, which may be similar to base platforms 102a, 102b, 102c of FIG. 1, that are connected via a daisy chain in a master-slave topology. In embodiments, the first base platform 202a may include a microcontroller unit (MCU) 202a1 to process information received directly or indirectly from: the base platform 202a; a computing device, such as computing device 101 of FIG. 1; a host object, such as host object 104 of FIG. 1, that may be placed on the base platform 202a; other base platforms 202b, 202c; and/or other sources such as legacy base platforms. In other embodiments, the MCU 202a1 may process information between a base platform 202a and external components such as remote controls, smartphones, and the like. In embodiments, the MCU 202a1 may provide controller functions to directly or to indirectly operate various mechanical and/or electromagnetic features on the base platform 202a as discussed further below.

In embodiments, the first base platform 202a may include data communications module 202a2 to allow input/output and other communications between the MCU 202a1 and the various components and/or objects described herein. In embodiments, data communications may include wired communications, for example, serial, Ethernet, universal serial bus (USB), FireWire, or other suitable wire-based communication devices and/or protocols. In embodiments, data communications may include wireless communications, for example, Bluetooth™ (BT), Bluetooth low energy (BLE), Wi-Fi, and the like. In embodiments, the data communication module 202a2 may be used to bridge a first base platform 202a to a legacy base platform (not shown).

In embodiments, the base platform 202a may include host object communication features 202a3 to allow communication with host objects, such as host object 104 of FIG. 1, that are placed on or near the base platform 202a. In embodiments, host object communication may include, in addition to the wireless communication protocols and processes discussed above, wireless communication that may be restricted to short distances. Examples of these may include but are not limited to near field communications (NFC) and radio-frequency identification (RFID). In embodiments, the host object communication 202a3 may include an NFC or RFID reader, with the host object 104 including an NFC or RFID tag or chip that may contain electronically stored digital information that may be modified. In embodiments, there may be multiple areas within the base platform 202a with host object communication 202a3 enabled. In embodiments, host object communication 202a3 between the base platform 202a and host object 104 may be bi-directional, which may allow the computing device such as computing device 101 of FIG. 1 to both read from and write to digital data within a host object 104 using host object communication 202a3. In embodiments, each of the base platforms 202a, 202b, 202c may contain unique identifiers to be combined with various communication messages so that various information and/or commands that are sent to and/or from the various base platforms 202a, 202b, 202c may have an identified source and/or destination.

In embodiments, the base platform 202a may include a power source 202a4 to provide power for the components within the base platform 202a, to other base platforms 202b, 202c that may be attached to the base platform 202a, or to host objects 104 that may be placed on the base platform 202a. In embodiments, the host objects 104, when placed on the base platform 202a, may be charged either by a direct wired connection to the power source 202a4 or by induction via the power source 202a4. In embodiments, the base platform 202a may plug into an external power source (not shown) such as a computing device 101, a wall outlet, or another suitable source of power to charge the power source 202a4. In embodiments, the power source 202a4 may be charged by an inductive power source (not shown) placed in proximity to the base platform 202a.

In embodiments, the other base platforms 202b, 202c may contain some or all of the components and functions described with respect to base platform 202a.

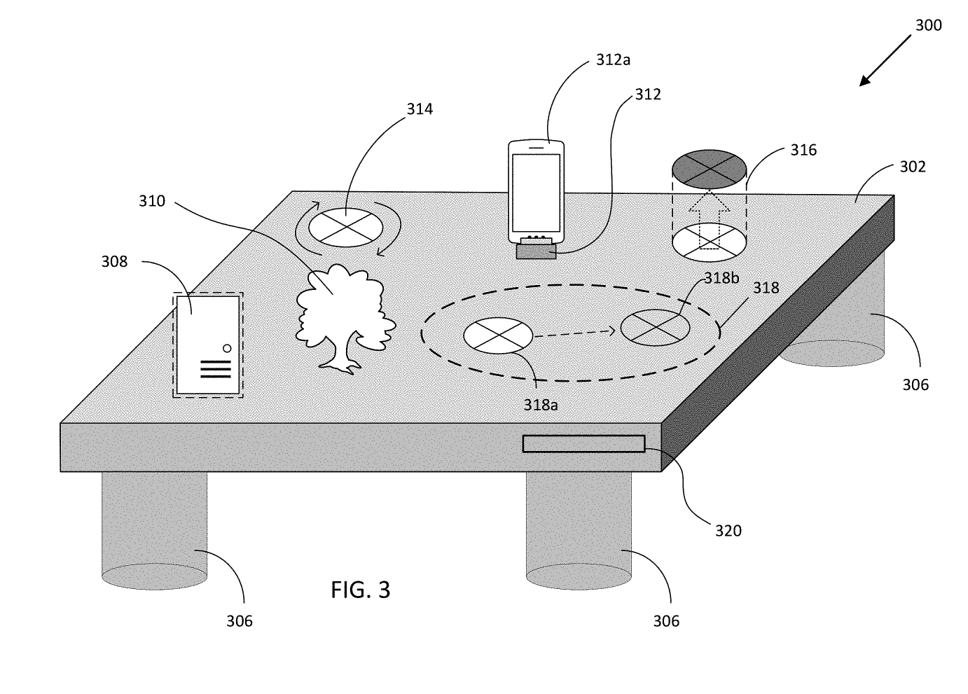

FIG. 3 illustrates features of an extended base platform, in accordance with some embodiments. Diagram 300 shows a base platform 302, which may be similar to base platform 202a of FIG. 2 that includes enhancements. In embodiments, the enhanced base platform 302 may include elements and functions that may enhance the interaction of host objects, such as host object 104 of FIG. 1, with a player and with a virtual reality game or environment associated with a connected computing device 101. In embodiments, the various base platform 302 elements and functions may operate based upon commands received by the base platform 302 from virtual reality game play. In embodiments, one or more host objects 104 may be placed upon the base platform 302.

In embodiments, the base platform 302 may include various ways to interact with a player or with a host object 104. These various ways to interact include, but are not limited to, movement of the base platform 302 by movable legs 306, positioning and/or movement of physical indicators 308, positioning and/or movement of scenery 310, positioning and/or movement of docking stations 312 onto which mobile apparatuses such as smartphone 312a may be docked. The various ways may also include, but are not limited to, rotational and/or other movement of areas such as rotational areas 314, vertical movement of areas such as vertical movement areas 316, and/or horizontal movement areas such as horizontal movement area 318, which may include a beginning location 318a and an ending location 318b. In addition, in embodiments, receptors 320 within the base platform 302 may allow a player to activate one or more of these interactions with the base platform through physical control or via remote control using light, sound, or wireless communication.

In embodiments, the base platform 302 may be raised, lowered, tilted and/or moved in some other 3-dimensional fashion. In embodiments this base platform 302 movement may be accomplished by movable legs 306. In embodiments, there may be four movable legs 306, as shown, or there may be some other number of legs suitable to move the base platform 302. In embodiments, the movable legs 306 may be implemented as pistons, or some other suitable mechanical device to raise or lower the movable legs 306.

In embodiments, various movements of the base platform 302 may be determined by the virtual reality game or environment in reaction to a player interaction, with movement instructions sent to the base platform microcontroller unit 202a1 of FIG. 2. In other embodiments, the movement of the base platform 302 may be determined based on the placement of a host object 104 being placed on the base platform 302. In other embodiments, the movement may be determined based upon inputs received from physical or remote control that may be received by the receptor 320.

In embodiments, base platform 302 movement may include raising one corner of the base platform 302 to indicate where to place a host object 104. In another example, the entire base platform 302 may be raised or lowered to identify the base platform 302 as the location onto which a host object 104 should be placed. In other embodiments, the base platform 302 may shake, vibrate, or otherwise provide haptic feedback that may indicate feedback from the virtual reality game or environment to the player to indicate the movement of a host object 104.

In embodiments, the base platform 302 may include indicators 308 that may physically move relative to the base platform 302. For example, an indicator 308 may push out from the base platform 302 to provide feedback to a player interacting with a virtual reality game or environment. For example, the indicator 308 may vary its position based upon virtual reality game or environment achievement levels, awards, triggers, and/or the success of the player in virtual reality gaming interactions. For example, the indicator 308 may indicate progress the player has made in the virtual environment, or may indicate a power level or other status associated with the host object 104 at the time the host object 104 is placed on the base platform 302.

In embodiments, the indicator 308 may be a physical object that may raise or may lower with respect to the base platform 302. For example, the indicator 308 may be a card or a thermometer that may raise or lower above or below a surface of the base platform 302. In embodiments, the indicator 308 may be a dial (not shown) or other physical indicator that may be part of a surface of the base platform 302. In embodiments, the indicator 308 may be a digital display.

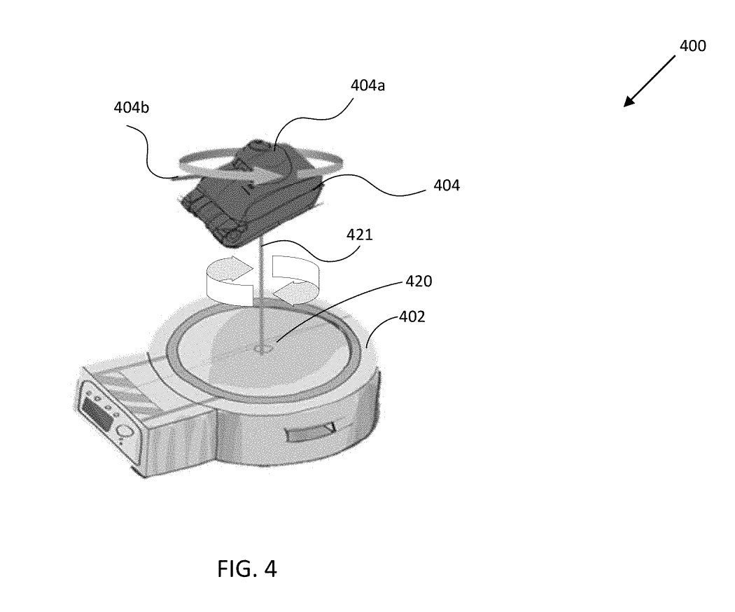

In embodiments, the base platform 302 may include scenery 310 that may pop up or may raise or lower with respect to a surface of the base platform 302. In embodiments, scenery 310 may appear and may move in response to placing a host object 104 on the base platform 302. For example, scenery 310 may include a tree (shown) that may pop up when a military-based host object 104, such as the tank host object 404 of FIG. 4B, may be placed on a surface of the base platform 302.

In embodiments, the base platform 302 may include a docking station 312 that may allow a player to dock a smartphone 312a or some other mobile device to the base platform 302. In embodiments, the docking station 312 may be in a fixed location with respect to a surface of the base platform, or it may be movable. For example, the docking station 312 may rise up from and/or lower into the base platform 302 depending on commands that the base platform 302 may receive from the virtual reality game or environment. In embodiments, a smartphone 312a that is docked in the docking station 312 may be used as a display to the player, or as a control for the base platform 302 or as a control for the virtual reality game or environment.

In embodiments, the base platform 302 may include host object movement areas 314, 316, 318 that may cause a host object 104, when placed on one of these areas, to move in various ways including rotationally, vertically (i.e., up and down), or horizontally, with respect to the base platform 302. In embodiments, these movements may be directly or indirectly controlled by a microcontroller, such as microcontroller 202a1 of FIG. 2, coupled with one or more motors, bands, magnets or other suitable movement apparatus. The microcontroller may base the movements upon information received from the host object 104 placed on the area and/or based upon information received directly or indirectly from the virtual reality game or environment.

In embodiments, the base platform 302 may include a rotational area 314 that may rotate a host object 104 that is placed on the rotational area 314 either clockwise or counterclockwise with respect to a surface of the base platform 302. In embodiments, the host object 104 may be rotated to show a relative direction or a change in direction of the virtual object represented by the host object 104 within the virtual game or environment. For example, if the virtual object in the virtual game or environment turns to the left, the host object placed on the rotational area 314 may rotate to the left. In embodiments, rotation may be used to indicate a status or condition of a virtual object in the virtual game or environment. For example, with the host object 104 placed on a rotational area 314, a rotation to the left may indicate a loss in player strength, and a rotation to the right may indicate an increase in player strength. In embodiments, rotation of the host object 104 by the rotational area 314 may be used for any other suitable indicator purposes.

In embodiments, the base platform 302 may include an vertical movement area 316, which may also be referred to as an elevator area, that may raise and/or lower a host object 104 with respect to a surface of the base platform 302. In embodiments, a host object 104 may be raised or lowered to identify the host object 104 to the player so that the host object 104 may be removed from the base platform 302. In embodiments, a host object 104 may be raised or lowered to identify an increase or decrease of loss in player strength within the virtual environment or game, or as a physical indication to the player of any other attributes of the virtual object represented by the host object 104. In embodiments, raising or lowering of the host object 104 by the vertical movement area 316 may be used for any other suitable indicator purposes.

In embodiments, the base platform 302 may include a host movement area 318 that may move a host object 104 placed on a beginning location 318a, which may also be referred to as a first area, to an ending location 318b, which may be referred to as a second area, on a surface of the base platform 302. In embodiments, there may be more than two areas within the host movement area 318 to which a host object 104 may be moved. In embodiments, a progression or other movement of an associated virtual object within a virtual area of the virtual game or environment may be physically represented by a movement in the host object 104.

In embodiments, areas within the host movement area 318 may also include sensors or other receiving mechanisms to read information from a host object 104. In embodiments, this information may be read if a player moves the host object 104 from the beginning location 318a to the ending location 318b.

In embodiments, the base platform 302 may include one or more receptors 320 that may receive physical input, for example, a finger touch from a player, or wireless input, for example, from a remote control (not shown). In embodiments, the receptor 320 may receive light signals or sound signals. The receptor 320 may be used to provide input to control the base platform 302 or host objects 104 that may be placed on the base platform 302. This may be in addition to input received from the virtual game or environment to which the base platform 302 may be directly or indirectly connected.

FIG. 4 illustrates features of an extended base platform used to articulate a host object, in accordance with some embodiments. Diagram 400 illustrates a base platform 402, which may be similar to base platform 302 of FIG. 3, with an object manipulation area 420, which may be similar to host object movement areas 314, 316, 318 of FIG. 3 that may be used to manipulate a host object 404, which may be similar to host object 104 of FIG. 1. In embodiments, when a host object 404 is placed on the object manipulation area 420, a manipulation rod 421 may extend upward from the surface of the base platform 402 and extend inside the host object 404 to cause portions of the host object 404 to move or to articulate.

In embodiments, a portion of the manipulation rod 421 may be above a surface of the base platform 402 before the host object 404 is placed on the object manipulation area 420. In embodiments, the manipulation rod 421 may rise up through a surface of the base platform 402 once the host object 404 is placed on the object manipulation area 420. In embodiments, the manipulation rod 421 may be controlled by a microcontroller, such as microcontroller 202a1 of FIG. 2 that may be coupled to one or more motors, sensors, actuators, bands, or other apparatuses within the base platform 402 that may control and/or cause the manipulation rod 421 to move.

In embodiments, as the manipulation rod 421 moves, the movement may cause portions of a host object 404 to move. For example, as shown, the turret portion 404a of the tank-shaped host object 404 may turn when the manipulation rod 421 is turned clockwise or counterclockwise. For example, moving manipulation rod 421 up or down, that may cause the canon 404b on the turret portion 404a to move up and down. Embodiments of other host objects 404 may be designed to have unique movements of parts of the host object 404 based upon varying movements of the manipulation rod 421.

In embodiments, the object manipulation area 420 may share other attributes with other active regions on the base platform 402 as described elsewhere herein. For example, the object manipulation area 420 may also read the data stored in the host object 404. In this way, it may be determined whether the host object 404 is able to be manipulated, how the host object 404 may be manipulated, and/or the sequence of movements by the manipulation rod 421 (or other manipulation mechanism) that may manipulate portions of the host object 404 in a desired manner. In embodiments, this desired manner may be based upon a state of the virtual reality game or environment. In embodiments, the object manipulation area 420 may also be to determine the various configurations of how portions of the host object 404 may be positioned. In embodiments, this may be based upon the data stored in the host object 404.

In embodiments, the host object 404 may be manipulated in other ways. For example, in embodiments the host object 404 may include various motors, sensors, actuators, a power source, and/or a receiver that may be connected within the host object 404. In embodiments, this connection may be wired or wireless. Commands to move or articulate portions of the host object 404 may be sent from the object manipulation area 420 to the host object 404. These commands may be sent via a manipulation rod 421, via wireless communication, or via wired electrical communication using, for example, manipulation rod 421. In other embodiments, portions of the host object 404 may be moved or articulated by use of electromagnets (not shown) or by some other suitable source of movement.

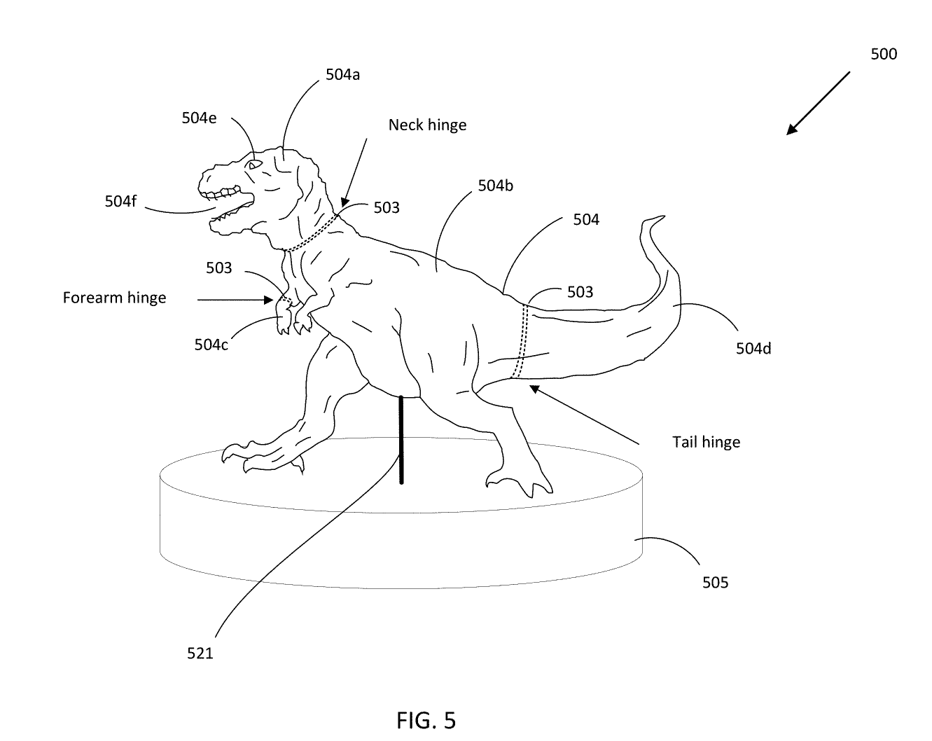

FIG. 5 illustrates a host figure with multiple articulations, in accordance with some embodiments. Diagram 500 shows a host object 504, which may be similar to host object 404 of FIG. 4 or to host object 104 of FIG. 1. As shown, the host object 504 is dinosaur-shaped object with articulation points 503 that divide the host object 504 into different components. These may include a head component 504a, a body component 504b, a right arm component 504c, a tail component 504d, an eye component 504e and/or a mouth component 504f. For example, the host object 504 may represent a dinosaur character in a virtual reality game, with positioning of the various components 504a-504f indicating a pending action or a state of ferocity of the associated virtual character at a particular point within the virtual reality game.

It should be noted that any shape with any number of articulations may be used for the host object 504, and that the example of host object 504 as a dinosaur-shaped object is not to imply any limitation. In embodiments, the size, shape, and/or structure of the host object 504 may be associated with the appearance of a corresponding virtual object within a virtual reality game or environment. In embodiments, the association between the host object 504 and the virtual object within the virtual reality game may be made when the host object 504 is placed on a base platform such as base platform 402 of FIG. 4.

A connector 521, which may be similar in embodiments to the manipulation rod 421 of FIG. 4, may be used to provide power to articulate various components 504a-504f of the host object 504. In embodiments, the connector 521 may alternatively be implemented as an electrical connection to provide power or data communications between the base platform (not shown) and motors within the host object 504. In embodiments, the various components 504a-504f may be connected by articulation points 503 to facilitate independent component movement. For example, the head component 504a may articulate independently of the body component 504b. In embodiments, the electrical and/or data connection may provide power and/or instructions to the host object 504, or to store information in the host object 504 for later retrieval when placed on a base platform as described above. In embodiments, the connector 521 may be an electrical connection, a physical connection, or a magnetic/electromagnetic connection.

In embodiments, a player may manually change the articulation of components 504a-504f while the host object 504 is either on or is not on the base platform 402. In embodiments, such a change in the articulation of components may cause a change in the digital data stored on the host object 504. For example, if a player were to open the mouth 504f of the dinosaur host object 504, that may increase the power level that is stored in the digital data of the dinosaur host object 504. The next time the dinosaur host object 504 is placed on a base platform 402, this increased power level may be transferred to the virtual reality game, and may cause the virtual representation of the dinosaur host object 504 to have the increased power level.

In embodiments, the virtual reality game or environment may cause the host object 504 to articulate and/or move in various ways to represent, for example, changes in the condition of the corresponding virtual character. For example, a stomach area of the host object 504 may be retracted or extended to simulate having a full meal or to simulate being pregnant. An arm 504c may be retracted or extended, or increased in diameter, to simulate growing muscles. Eyes 504e may be bulged to make the host object 504 appear to be crazed or angry. Bumps (not shown) on the outside of the host object 504 may indicate a disease or that a transformation may be in progress. Horns (not shown) may be retracted or extended. A mouth 504f may be moved or a tongue (not shown) may be extended or retracted to simulate speech. Nails/or claws (not shown) may be curled in or extended out to indicate a pending attack. In a similar fashion, other such movement by the host object 504 may represent changes in the state of the corresponding figure of the host object 504 in the virtual reality game.

In embodiments, a host object 504 may include a host object base 505. In embodiments, the host object base 505 may provide stable way for the host object 504 to be placed onto a base platform 402. In embodiments, the host object base 505 may provide an area for any motors, power source, receivers, and the like as referred to above that may be used to articulate or facilitate the articulation of components 504a-504f of the host object 504. In embodiments, facilitating articulation of components may include facilitating interaction with the various mechanisms found within a base platform such as base platforms 202a, 202b of FIG. 2, 302 of FIG. 3, or 402 of FIG. 4. In embodiments, the host object base 505 may include controllers, processors, memory, sensors, and/or related components that may be used to identify and/or store various states of the host object 504, including the position of articulations of the various host object components 504a-504f.

In embodiments, a portion of the host object 504 may be made of Electro Active Polymers (EAP) that include materials that demonstrate a change in size or shape when stimulated by an electric field. In embodiments, when implemented as or in combination with components of the host object 504, for example, as a head component 504a, a body component 504b, a right arm component 504c, or a tail component 504d, applying an electric field to EAP may cause the respective components to move. For example, by applying an electric field and/or electric current to the tail component 504d may cause the tail component to contract and to move in an upward direction. In embodiments, varying the rate of change of the electric field or the electric current may vary the speed at which the component may react.

In embodiments, the connection 521 may include one or more threads (not shown) made out of EAP material so that when a thread is stimulated through an electrical current or an electrical field the thread may expand or contract, causing the tail component 504d of the host object 504 connected to the thread to move. In embodiments, applying varying voltages to the thread may cause varying degrees of contraction and/or flexing of the thread, thus causing the tail component 504d to, for example, wiggle. In embodiments, the EAP threads may be located inside the toy hinges connecting the various components 504a-504f.

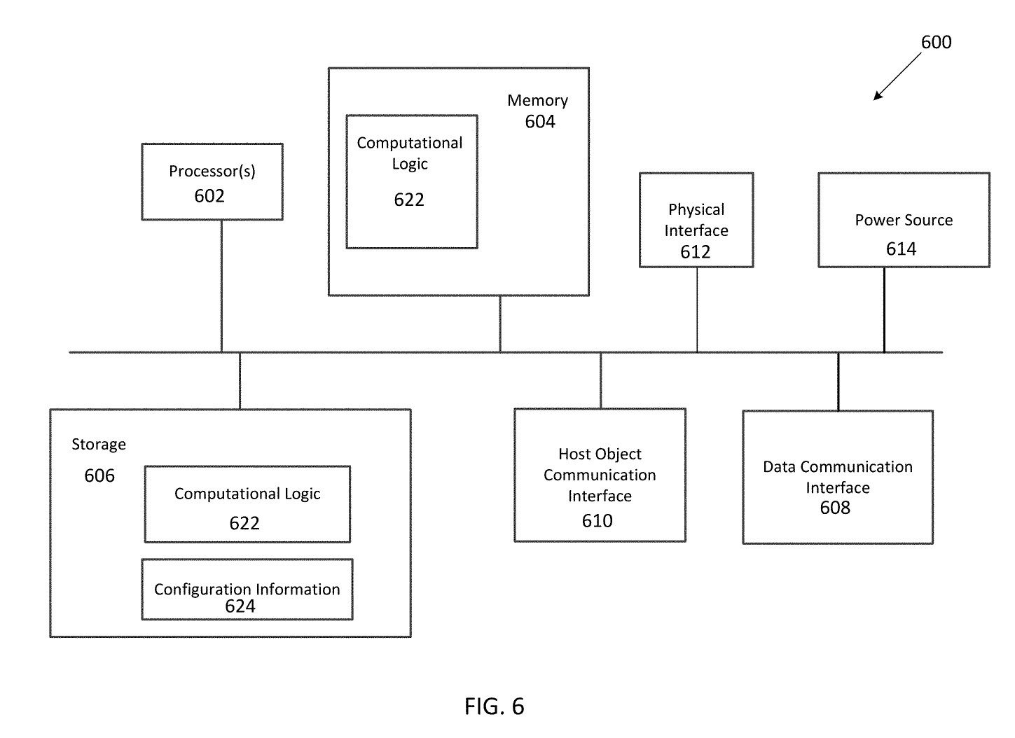

FIG. 6 is a block diagram illustrating various components of an extended base platform, in accordance with some embodiments. Diagram 600 may show a block diagram of an extended base platform, such as base platform 302 FIG. 3, having various components that may be in a base platform. Embodiments may include a processor 602, which may also be referred to as an MCU such as MCU 202a1 of FIG. 2 that may execute computational logic 622 that may be used to operate one or more base platforms 202a-202c. The computational logic 622 may exist in a non-volatile storage area 606, which may be transferred by the processor 602 or by some other process to the memory 604 for execution by the processor 602.

In embodiments, the computational logic 622 may identify the capabilities of the base platform, such as base platform 302 of FIG. 3, through configuration information 624 that may reside within storage 606. In embodiments, the computational logic 622 may identify other base platforms, such as base platforms 202b-202c, to which it is attached via data communication interface 608. In embodiments, this interface may connect USB, or other wired and/or wireless communication processes/protocols serving an input/output (I/O) interface function. In embodiments, the data communication interface 608 may connect to a computing device, such as computing device 101 of FIG. 1, that may be connected to a virtual reality game or environment that may generate data to be directly or indirectly used by the computational logic 622.

In embodiments, the computational logic 622 may identify one or more host objects, for example, host object 104 of FIG. 1 or host object 504 of FIG. 5, that may be attached to the base platform via data from the host object communication interface 610. In embodiments, the host object communication interface 610 may include NFC, RFID, BLE, or other communication process/protocols to read data from the host object 504, which then may be sent by the data communication interface 608 to the virtual reality game or environment to indicate player information or other input.

In embodiments, the computational logic 622 may interact with physical features of the base platform 302 as may be described for FIG. 3 above by receiving information from an/or sending information or commands to a physical interface 612. In embodiments, the physical interface 612 may include an interface to control sensors, actuators, motors, and/or other mechanisms to cause physical interactions between a player and a base platform 302, and/or a host object 504 and a base platform 302, as described above.

In embodiments, a power source 614 may be used to provide power to one or more base platforms 202a-202c or, in embodiments, to a host object 504 that may be placed on the base platform 202a.

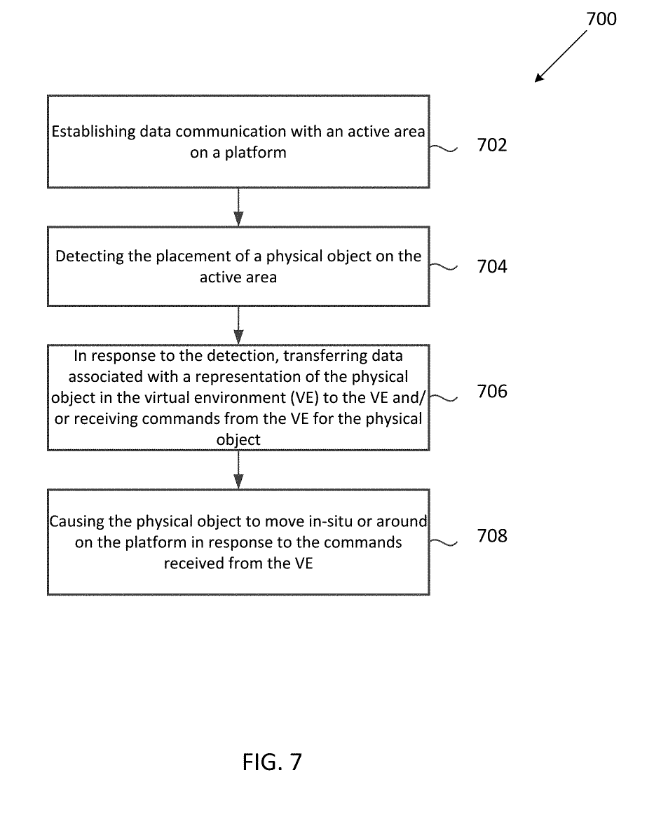

FIG. 7 is a block diagram that illustrates a process for providing a base platform for use with a VE, in accordance with some embodiments. In some embodiments, base platform 102a-102c of FIG. 1, base platform 202a-202c of FIG. 2, base platform 302 of FIG. 3, and base platform 402 of FIG. 4 may perform one or more processes, such as the process 700.

At block 702, the process may include establishing data communication with an active area on a platform. In embodiments, the platform 302 of FIG. 3 may include active areas 314, 316, 318, 318a, 318b, and/or platform 402 of FIG. 4, with active area (object manipulation area) 420.

At block 704, the process may include detecting the placement of a physical object on the active area. In embodiments, the physical object may include object 104 of FIG. 1, object 404 of FIG. 4, and/or object 504 of FIG. 5.

At block 706, the process may include in response to the detection, transferring data associated with a representation of the physical object in the virtual environment (VE) to the VE and/or receiving commands from the VE for the physical object. In embodiments, the physical object may be referred to in block 704. The VE (not shown) may be connected to the computing device 101 of FIG. 1. In embodiments, part or all of the VE may run on computing device 101. In embodiments, the VE may run on one or more servers (not shown) that are connected to the computing device 101. In embodiments, information and/or data for a physical object may be exchanged between the physical object and the VE (not shown) via the computing device 101.

At block 708, the process may include causing the physical object to move in-situ or around on the platform in response to the commands received from the VE. As described above, in embodiments part or all of the VE may run on computing device 101 of FIG. 1. In embodiments, information in the form of commands may be generated by the VE and sent to a platform, for example, platform 302 of FIG. 3. Therefore if a physical object, such as physical object 504 of FIG. 5, is placed on one of the active areas as described above, commands may cause the physical object 504 to move when placed on rotational area 314, vertical movement area 316, or move around on the platform 318, 318a, 318b.

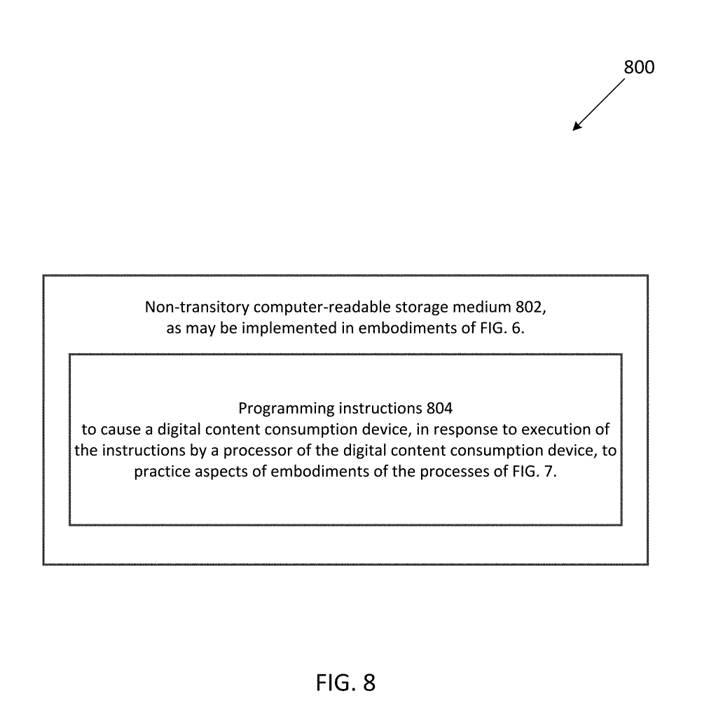

FIG. 8 is a diagram 800 illustrating computer-readable media 802 having instructions for practicing the above-described techniques, or for programming/causing systems and devices to perform the above-described techniques, in accordance with various embodiments. In some embodiments, such computer-readable media 802 may be included in a memory or storage device, which may be transitory or non-transitory, of the apparatus diagram 600 of FIG. 6. In embodiments, instructions 804 may include assembler instructions supported by a processing device, or may include instructions in a high-level language, such as C, that can be compiled into object code executable by the processing device. In some embodiments, a persistent copy of the computer-readable instructions 804 may be placed into a persistent storage device in the factory or in the field (through, for example, a machine-accessible distribution medium (not shown)). In some embodiments, a persistent copy of the computer readable instructions 804 may be placed into a persistent storage device through a suitable communication pathway (e.g., from a distribution server).

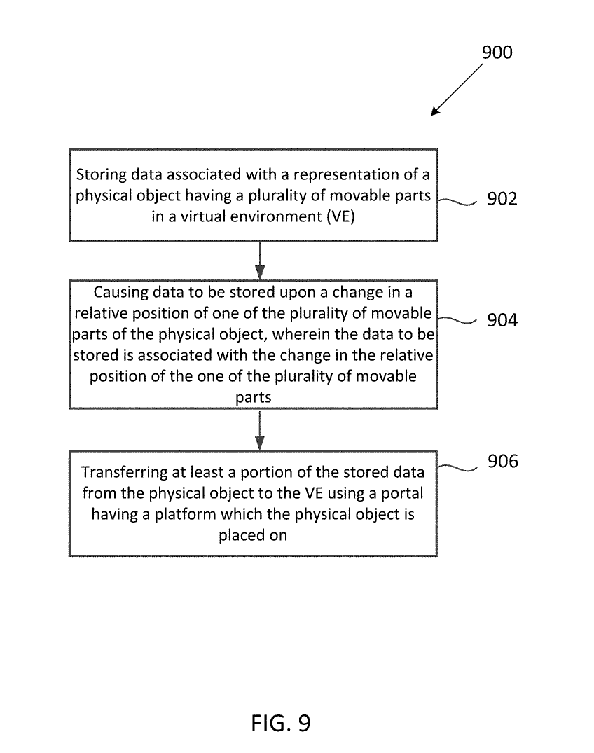

FIG. 9 is a block diagram illustrating a process for implementing a physical object to be used on a portal in conjunction with a VE, in accordance with some embodiments. Embodiments may perform one or more processes, such as the process 900.

At block 902, the process may include storing data associated with a representation of a physical object having a plurality of movable parts in a VE. In embodiments, the physical object 504 of FIG. 5 has a plurality of movable parts including the head 504a, body 504b, arms 504c, tail 504d, eyes 504e, and mouth 504f.

At block 904, the process may include causing data to be stored upon a change in a relative position of one of the plurality of movable parts of the physical object, wherein the data to be stored is associated with the change in the relative position of the one of the plurality of movable parts. In embodiments, a movement in a host object 504 of FIG. 5, for example, twisting the head 504a around the articulation point 503, may cause data representing that motion to be stored within the base 505.

At block 906, the process may include transferring at least a portion of the stored data from the physical object to the VE using a portal having a platform which the physical object is placed on. In embodiments, the data may be stored in the physical object base 505, and may be accessible via connector 521 to an active platform 302 of FIG. 3, and to a computing device 101 of FIG. 1. to the VE (not shown).

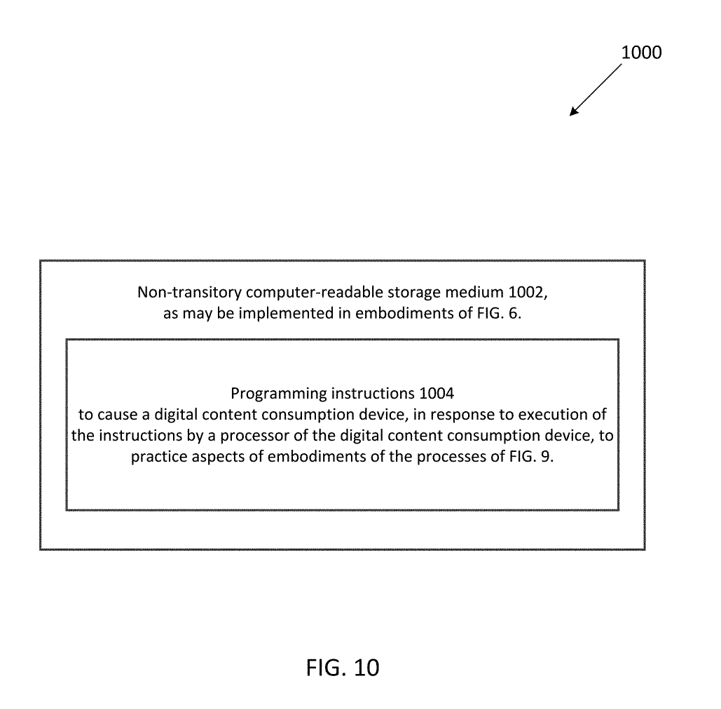

FIG. 10 is a diagram 1000 illustrating computer-readable media 1002 having instructions for practicing the above-described techniques, or for programming/causing systems and devices to perform the above-described techniques, in accordance with various embodiments. In some embodiments, such computer-readable media 1002 may be included in a memory or storage device, which may be transitory or non-transitory, of the apparatus diagram 600 of FIG. 6. In embodiments, instructions 1004 may include assembler instructions supported by a processing device, or may include instructions in a high-level language, such as C, that can be compiled into object code executable by the processing device. In some embodiments, a persistent copy of the computer-readable instructions 1004 may be placed into a persistent storage device in the factory or in the field (through, for example, a machine-accessible distribution medium (not shown)). In some embodiments, a persistent copy of the computer readable instructions 1004 may be placed into a persistent storage device through a suitable communication pathway (e.g., from a distribution server).

The corresponding structures, material, acts, and equivalents of all means or steps plus function elements in the claims below are intended to include any structure, material or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

### EXAMPLES

Examples, according to various embodiments, may include the following.

Example 1 may be a portal apparatus for use with a virtual environment (VE), comprising: a platform to receive a physical object that includes data associated with a representation of the physical object in the VE; a controller coupled with the platform to transfer all or part of the data between the physical object and the VE when the physical object is placed on the platform; and a communication interface coupled with the controller to couple the portal apparatus to a host apparatus of the VE or to another portal apparatus that is directly or indirectly coupled to the host apparatus, to propagate the data to the VE, directly to the host apparatus, or indirectly via one or more of the other portal apparatuses.

Example 2 may include the portal apparatus of example 1, wherein the controller is further to: identify, using the communication interface, one of the other portal apparatuses with another physical object placed on a platform of the one of the other portal apparatuses; transfer, using the communication interface, all or part of the data between the another physical object and the host apparatus of the VE directly, or indirectly via the one or more of the other portal apparatuses.

Example 3 may include the portal apparatus of example 1, wherein the communication interface supports wired connections that include serial, Ethernet, and/or universal serial bus (USB) protocols.

Example 4 may include the portal apparatus of example 1, wherein the communication interface supports wireless connections that include Bluetooth, Bluetooth low energy (BLE), and/or Wi-Fi protocols.

Example 5 may include the portal apparatus of example 1, wherein the other portal apparatuses are in a master-slave configuration, a daisy-chain configuration, and/or a mesh network configuration.

Example 6 may include the portal apparatus of example 1, wherein the portal apparatus and the one or more of the other portal apparatuses correspond to different virtual locations within the VE.

Example 7 may include the portal apparatus of any one of examples 1-6, wherein the physical object is a toys-to-life (TTL) object and the VE is a TTL VE.

Example 8 may be a method for providing a portal for use with a virtual environment (VE), comprising: receiving data from a physical object associated with a representation of the physical object in the VE, wherein the physical object is on a platform of a portal apparatus; and transferring all or part of the received data between the physical object and the VE when the physical object is placed on the platform; wherein the data is propagated from the portal apparatus to a host apparatus of the VE either directly or indirectly via one or more other portal apparatuses.

Example 9 may include the method of example 8, further comprising: identifying one of the other portal apparatuses with another physical object placed on a platform of the one of the other portal apparatuses; and transferring all or part of the data between the another physical object and the host apparatus of the VE directly, or indirectly via the one or more of the other portal apparatuses.

Example 10 may include the method of example 8, wherein transferring or propagating all or part of the received data further includes transferring or propagating via wired connections or wireless connections.

Example 11 may include the method of example 10, wherein the wired connections include serial, Ethernet, and/or universal serial bus (USB), and the wireless connections include Bluetooth, Bluetooth low energy (BLE), and/or Wi-Fi.

Example 12 may include the method of example 8, wherein the other portal apparatuses are in a master-slave configuration, a daisy-chain configuration, and/or a mesh network configuration.

Example 13 may include the method of example 8, wherein the portal apparatus and the one or more of the other portal apparatuses correspond to different virtual locations within the VE.

Example 14 may include the method of any one of examples 8-13, wherein the physical object is a toys-to-life (TTL) object and the VE is a TTL VE.

Example 15 may be a portal apparatus for use with a virtual environment (VE), comprising: a platform that includes an active area; and a controller coupled with the active area to transfer data associated with a representation of a physical object in the VE, to the VE, after the physical object is placed on the active area, and receive commands from the VE with respect to the physical object; wherein the controller is further to cause the physical object to move in-situ or around on the platform, in response to the commands received from the VE after the physical object has been placed on the active area.

Example 16 may include the portal apparatus of example 15, wherein the controller is to raise the platform, lower the platform, or tilt the platform at an angle.

Example 17 may include the portal apparatus of example 15, wherein the controller is to cause the physical object, when placed on the active area, to move up, to move down, to rotate clockwise, or to rotate counterclockwise based on an orientation of the apparatus.

Example 18 may include the portal apparatus of example 17, wherein the controller is further to cause motors, bands, gears, and/or electromagnets to move within the portal apparatus to facilitate movement of the physical object.

Example 19 may include the portal apparatus of example 15, wherein the controller is to cause the physical object, when placed on the active area, to move to a different location within the active area.

Example 20 may include the portal apparatus of example 15, wherein the controller is to cause indicators within the platform to move.

Example 21 may include the portal apparatus of example 15, wherein the controller is to cause scenery within the platform to appear, disappear, or move.

Example 22 may include the portal apparatus of example 15, wherein the controller is to raise, lower, or otherwise move a docking station with respect to the platform.

Example 23 may include the portal apparatus of example 22, wherein the docking station is to receive a smartphone or a tablet.

Example 24 may include the portal apparatus of example 23, wherein the smartphone or the tablet is further to couple with the controller and to cause one or more actions to be performed on behalf of the controller.

Example 25 may include the portal apparatus of example 15, wherein to cause a portion of the physical object to move in-situ further includes to move: one or more arms, one or more legs, a hand to cause it to change position, the position of a head, the position of a mouth, the extension of a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or other portion of the physical object.

Example 26 may include the portal apparatus of example 25, wherein to cause a portion of the physical object to move in-situ further includes to cause an electric current or an electric field to be applied to an electro active polymer (EAP) that makes up a portion of the physical object or connected to the physical object to cause a part of the physical object to move.

Example 27 may include the portal apparatus of example 25, wherein to cause a portion of the physical object to move in-situ further includes to insert a rod into the physical object to implement a mechanical connection, wherein manipulation of the rod once inserted will cause portions of the physical object to move in-situ.

Example 28 may include the portal apparatus of example 25, wherein to cause a portion of the physical object to move in-situ further includes to transmit data by the portal apparatus to the physical object, wherein the physical object is able to cause portions of the physical object to move in-situ.

Example 29 may be a method for providing a portal for use with a virtual environment (VE), comprising: providing an active area on a platform of a portal apparatus; placing a physical object on the active area; transferring data associated with a representation of the physical object in the VE to the VE and/or receiving commands from the VE for the physical object; and causing the physical object to move in-situ or around on the platform in response to the commands received from the VE.

Example 30 may include the method of example 29, further comprising raising the platform, lowering the platform, or tilting the platform at an angle.

Example 31 may include the method of example 29, further comprising causing the physical object, when placed on the active area, to move up, to move down, to rotate clockwise, or to rotate counterclockwise based on an orientation of the apparatus.

Example 32 may include the method of example 31, further comprising causing motors, bands, gears, and/or electromagnets to move within the portal apparatus to facilitate movement of the physical object.

Example 33 may include the method of example 29, further comprising causing the physical object, when placed on the active area, to move to a different location within the active area.

Example 34 may include the method of example 29, further comprising causing indicators within the platform to move.

Example 35 may include the method of example 29, further comprising causing scenery within the platform to appear, disappear, or move.

Example 36 may include the method of example 29, further comprising causing to raise, lower, or otherwise move a docking station with respect to the platform.

Example 37 may include the method of example 36, further comprising causing the docking station to receive a smartphone or a tablet.

Example 38 may include the method of example 37, wherein the smartphone or the tablet is further to couple with the controller and to cause one or more actions to be performed on behalf of the controller.

Example 39 may include the method of example 29, wherein to causing a portion of the physical object to move in-situ further includes causing to move: one or more arms, one or more legs, a hand to cause it to change position, the position of a head, the position of a mouth, the extension of a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or other portion of the physical object.

Example 40 may include the method of example 39, wherein causing a portion of the physical object to move in-situ further includes causing an electric current or an electric field to be applied to an electro active polymer (EAP) that makes up a portion of the physical object or connected to the physical object to cause a part of the physical object to move.

Example 41 may include the method of example 39, wherein causing a portion of the physical object to move in-situ further includes inserting a rod into the physical object to implement a mechanical connection, wherein manipulating the rod once inserted will cause portions of the physical object to move in-situ.

Example 42 may include the method of example 39, wherein causing a portion of the physical object to move in-situ further includes transmitting data by the portal apparatus to the physical object, wherein the physical object is to cause portions of the physical object to move in-situ.

Example 43 may be a physical object to be used with a virtual environment (VE), comprising: a plurality of movable parts; a data store to store data associated with a representation of the physical object in the VE, wherein a change in a relative position of one of the plurality of movable parts triggers storage of data associated with the change in the relative position in the data store; and a communication interface coupled to the data store to transfer at least a portion of the stored data from the physical object to the VE via a portal having a platform which the physical object is placed on.

Example 44 may include the physical object of example 43, wherein the communication interface is to transfer data from the VE to the portal having a platform which the physical object is placed on.

Example 45 may include the physical object of example 43, wherein the physical object is a toys-to-life (TTL) object.

Example 46 may include the physical object of example 43, wherein the data store is in a base of the physical object.

Example 47 may include the physical object of example 43, wherein a first of the plurality of moveable parts of the physical object is to change a relative position by the portal platform when the physical object is placed on the portal platform or by a player when the physical object is placed on the portal platform or is not placed on the portal platform.

Example 48 may include the physical object of example 47, wherein movement of the first of the plurality of moveable parts includes a removal of the first of the plurality of moveable parts from the physical object.

Example 49 may include the physical object of example 47, wherein the change of the relative position of the first of the plurality of movement of the plurality of moveable parts includes a movement of: one or more arms, one or more legs, a hand, a head, a mouth, a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or some other portion of the physical object.

Example 50 may include the physical object of example 47, wherein the physical object is placed on the portal platform; and wherein the portal is to cause the first of the plurality of moveable parts of the physical object to change a relative position based upon an electric current or an electric field applied by the portal to an electro active polymer (EAP) included in the first of the plurality of moveable parts of the physical object or that is connected to the first of the plurality of moveable parts of the physical object.

Example 51 may include the physical object of example 47, wherein the physical object is placed on the portal platform; and wherein the portal is to insert a rod into the physical object to implement a mechanical connection with the physical object, wherein manipulation of the rod is to cause the first of the plurality of moveable parts of the physical object to change a relative position.

Example 52 may include the physical object of example 47, wherein the physical object is placed on the portal platform; and wherein the portal is to provide instructions to the physical object to cause the first of the plurality of moveable parts of the physical object to change a relative position.

Example 53 may include the physical object of example 52, wherein to provide instructions further includes to provide instructions via Bluetooth, Bluetooth low energy (BLE), RFID, NFC, or electromagnetically.

Example 54 may include the physical object of example 52, wherein the physical object further comprises: one or more sensors to receive the instructions from the portal apparatus; one or more motors or mechanisms to cause the first of the plurality of moveable parts of the physical object to change a relative position based upon the received instructions.

Example 55 may be a method to implement a physical object to be used with a virtual environment (VE), comprising: storing data associated with a representation of the physical object having a plurality of movable parts in the VE; causing data to be stored upon a change in a relative position of one of the plurality of movable parts of the physical object, wherein the data to be stored is associated with the change in the relative position of the one of the plurality of movable parts; transferring at least a portion of the stored data from the physical object to the VE using a portal having a platform which the physical object is placed on.

Example 56 may include the method of example 55, further comprising transferring data from the VE to the portal having the platform on which the physical object is placed.

Example 57 may include the method of example 55, wherein the physical object is a toys-to-life (TTL) object.

Example 58 may include the method of example 55, wherein the data store is in a base of the physical object.

Example 59 may include the method of example 55, wherein causing a change in a relative position of a first of the plurality of movable parts of the physical object by the portal platform when the physical object is placed on the portal platform or by a player when the physical object is placed on the portal platform or is not placed on the portal platform.

Example 60 may include the method of example 59, wherein the relative change of position of the first of the plurality of moveable parts includes a removal of the first of the plurality of moveable parts from the physical object.

Example 61 may include the method of example 59, wherein changing the relative position of the first of the plurality of movement of the plurality of moveable parts includes moving: one or more arms, one or more legs, a hand, a head, a mouth, a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or some other portion of the physical object.

Example 62 may include the method of example 59, further comprising placing the physical object on the portal platform; and causing the first of the plurality of moveable parts of the physical object to change a relative position based upon an electric current or an electric field applied by the portal to an electro active polymer (EAP) included in the first of the plurality of moveable parts of the physical object or that is connected to the first of the plurality of moveable parts of the physical object.

Example 63 may include the method of example 59, further comprising placing the physical object on the portal platform; and causing the portal to insert a rod into the physical object to implement a mechanical connection with the physical object, wherein manipulation of the rod is to cause the first of the plurality of moveable parts of the physical object to change a relative position.

Example 64 may include the method of example 59, further comprising placing the physical object on the portal platform; and causing the portal to provide instructions to the physical object to cause the first of the plurality of moveable parts of the physical object to change a relative position.

Example 65 may include the method of example 64, wherein to provide instructions further includes to provide instructions via Bluetooth, Bluetooth low energy (BLE), RFID, NFC, or electromagnetically.

Example 66 may include the method of example 64, wherein the physical object further comprises: one or more sensors to receive the instructions from a portal apparatus; one or more motors or mechanisms to cause the first of the plurality of moveable parts of the physical object to change a relative position based upon the received instructions.

Example 67 may be one or more computer-readable media comprising instructions that cause a computing device, in response to execution of the instructions by the computing device, to: establish data communication with an active area on a platform of a portal apparatus; and in response to placement of a physical object on the active area, transfer data associated with a representation of a physical object in a VE to the VE and/or receive commands from the VE for the physical object; and cause the physical object to move in-situ or around on the platform in response to the commands received from the VE.

Example 68 may include the one or more computer-readable media of example 67, further comprising to raise the platform, to lower the platform, or to tilt the platform at an angle.

Example 69 may include the one or more computer-readable media of example 67, further comprising to cause the physical object, when placed on the active area, to move up, to move down, to rotate clockwise, or to rotate counterclockwise based on an orientation of the apparatus.

Example 70 may include the one or more computer-readable media of example 69, further comprising to cause motors, bands, gears, and/or electromagnets to move within the portal apparatus to facilitate movement of the physical object.

Example 71 may include the one or more computer-readable media of example 67, further comprising causing the physical object, when placed on the active area, to move to a different location within the active area.

Example 72 may include the one or more computer-readable media of example 67, further comprising to cause indicators within the platform to move.

Example 73 may include the one or more computer-readable media of example 67, further comprising to cause scenery within the platform to appear, disappear, or move.

Example 74 may include the one or more computer-readable media of example 67, further comprising to cause to raise, lower, or otherwise move a docking station with respect to the platform.

Example 75 may include the one or more computer-readable media of example 74, further comprising to cause the docking station to receive a smartphone or a tablet.

Example 76 may include the one or more computer-readable media of example 75, wherein the smartphone or the tablet is further to couple with a controller and to cause one or more actions to be performed on behalf of the controller.

Example 77 may include the one or more computer-readable media of example 67, wherein to cause a portion of the physical object to move in-situ further includes to cause to move: one or more arms, one or more legs, a hand to cause it to change position, the position of a head, the position of a mouth, the extension of a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or other portion of the physical object.

Example 78 may include the one or more computer-readable media of example 77, wherein to cause a portion of the physical object to move in-situ further includes to cause an electric current or an electric field to be applied to an electro active polymer (EAP) that makes up a portion of the physical object or connected to the physical object to cause a part of the physical object to move.

Example 79 may include the one or more computer-readable media of example 77, wherein to cause a portion of the physical object to move in-situ further includes to cause insertion of a rod into the physical object to implement a mechanical connection, wherein to cause a manipulation of the rod once inserted will cause portions of the physical object to move in-situ.

Example 80 may include the one or more computer-readable media of example 77, wherein to cause a portion of the physical object to move in-situ further includes to transmit data by the portal apparatus to the physical object, wherein the physical object is to cause portions of the physical object to move in-situ.

Example 81 may be one or more computer-readable media comprising instructions that cause a computing device, in response to execution of the instructions by the computing device, to: store data associated with a representation of a physical object having a plurality of movable parts in a VE; cause data to be stored upon a change in a relative position of one of the plurality of movable parts of the physical object, wherein the data to be stored is associated with the change in the relative position of the one of the plurality of movable parts; transfer at least a portion of the stored data from the physical object to the VE using a portal having a platform which the physical object is placed on.

Example 82 may include the one or more computer-readable media of example 81, further comprising to transfer data from the VE to the portal having the platform on which the physical object is placed.

Example 83 may include one or more computer-readable media of example 81, wherein the physical object is a toys-to-life (TTL) object.

Example 84 may include the one or more computer-readable media of example 81, wherein the data store is in a base of the physical object.

Example 85 may include the one or more computer-readable media of example 81, further comprising to cause a change in a relative position of a first of the plurality of movable parts of the physical object by the portal platform when the physical object is placed on the portal platform or by a player when the physical object is placed on the portal platform or is not placed on the portal platform.

Example 86 may include the one or more computer-readable media of example 85, wherein the relative change of position of the first of the plurality of moveable parts includes a removal of the first of the plurality of moveable parts from the physical object.

Example 87 may include the one or more computer-readable media of example 85, wherein to change the relative position of the first of the plurality of movement of the plurality of moveable parts includes to move: one or more arms, one or more legs, a hand, a head, a mouth, a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or some other portion of the physical object.

Example 88 may include the one or more computer-readable media of example 85, further comprising to cause the first of the plurality of moveable parts of the physical object to change a relative position based upon an electric current or an electric field applied by the portal to an electro active polymer (EAP) included in the first of the plurality of moveable parts of the physical object or that is connected to the first of the plurality of moveable parts of the physical object.

Example 89 may include the one or more computer-readable media of example 85, further comprising to cause the portal to insert a rod into the physical object to implement a mechanical connection with the physical object, wherein manipulation of the rod is to cause the first of the plurality of moveable parts of the physical object to change a relative position.

Example 90 may include the one or more computer-readable media of example 85, further comprising to cause the portal to provide instructions to the physical object to cause the first of the plurality of moveable parts of the physical object to change a relative position.

Example 91 may include the one or more computer-readable media of example 90, wherein to provide instructions further includes to provide instructions via Bluetooth, Bluetooth low energy (BLE), RFID, NFC, or electromagnetically.

Example 92 may include the one or more computer-readable media of example 90, wherein the physical object further comprises: one or more sensors to receive the instructions from a portal apparatus; one or more motors or mechanisms to cause the first of the plurality of moveable parts of the physical object to change a relative position based upon the received instructions.

Example 93 may be a portal apparatus for use with a virtual environment (VE), comprising: means for receiving data from a physical object associated with a representation of the physical object in the VE, wherein the physical object is on a platform; means for transferring all or part of the received data between the physical object and the VE when the physical object is placed on the platform; wherein the data is propagated from the portal apparatus to a host apparatus of the VE either directly or indirectly via one or more other portal apparatuses.

Example 94 may include the portal apparatus of example 93, further comprising: means for identifying one of the other portal apparatuses with another physical object placed on a platform of the one of the other portal apparatuses; and means for transferring all or part of the data between the another physical object and the host apparatus of the VE directly, or indirectly via the one or more of the other portal apparatuses.

Example 95 may include the portal apparatus of example 93, wherein transferring or propagating all or part of the received data further includes transferring or propagating via wired connections or wireless connections.

Example 96 may include the portal apparatus of example 95, wherein the wired connections include serial, Ethernet, and/or universal serial bus (USB), and the wireless connections include Bluetooth, Bluetooth low energy (BLE), and/or Wi-Fi.

Example 97 may include the portal apparatus of example 93, wherein the other portal apparatuses are in a master-slave configuration, a daisy-chain configuration, and/or a mesh network configuration.

Example 98 may include the portal apparatus of example 93, wherein the portal apparatus and the one or more of the other portal apparatuses correspond to different virtual locations within the VE.

Example 99 may include the portal apparatus of any one of examples 93-98, wherein the physical object is a toys-to-life (TTL) object and the VE is a TTL VE.

Example 100 may be a portal apparatus for use with a virtual environment (VE), comprising: means for providing an active area on a platform; means for placing a physical object on the active area; means for transferring data associated with a representation of the physical object in the VE to the VE and/or receiving commands from the VE for the physical object; and means for causing the physical object to move in-situ or around on the platform in response to the commands received from the VE.

Example 101 may include the portal apparatus of example 100, further comprising means for raising the platform, means for lowering the platform, or means for tilting the platform at an angle.

Example 102 may include the portal apparatus of example 100, further comprising means for causing the physical object, when placed on the active area, to move up, to move down, to rotate clockwise, or to rotate counterclockwise based on an orientation of the apparatus.

Example 103 may include the portal apparatus of example 102, further comprising means for causing motors, bands, gears, and/or electromagnets to move within the portal apparatus to facilitate movement of the physical object.

Example 104 may include the portal apparatus of example 100, further comprising means for causing the physical object, when placed on the active area, to move to a different location within the active area.

Example 105 may include the portal apparatus of example 100, further comprising means for causing indicators within the platform to move.

Example 106 may include the portal apparatus of example 100, further comprising means for causing scenery within the platform to appear, disappear, or move.

Example 107 may include the portal apparatus of example 100, further comprising means for causing to raise, lower, or otherwise move a docking station with respect to the platform.

Example 108 may include the portal apparatus of example 107, further comprising causing the docking station to receive a smartphone or a tablet.

Example 109 may include the portal apparatus of example 108, wherein the smartphone or the tablet is further to couple with a controller; and means for causing one or more actions to be performed on behalf of the controller.

Example 110 may include the portal apparatus of example 100, wherein means for causing a portion of the physical object to move in-situ further includes means for causing to move: one or more arms, one or more legs, a hand to cause it to change position, the position of a head, the position of a mouth, the extension of a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or other portion of the physical object.

Example 111 may include the portal apparatus of example 110, wherein means for causing a portion of the physical object to move in-situ further includes means for causing an electric current or an electric field to be applied to an electro active polymer (EAP) that makes up a portion of the physical object or connected to the physical object to cause a part of the physical object to move.

Example 112 may include the portal apparatus of example 110, wherein means for causing a portion of the physical object to move in-situ further includes means for inserting a rod into the physical object to implement a mechanical connection, wherein manipulating the rod once inserted will cause portions of the physical object to move in-situ.

Example 113 may include the portal apparatus of example 110, wherein means for causing a portion of the physical object to move in-situ further includes means for transmitting data by the portal apparatus to the physical object, wherein the physical object is to cause portions of the physical object to move in-situ.

Example 114 may be a physical object apparatus to be used with a virtual environment (VE), comprising: means for storing data associated with a representation of the physical object having a plurality of movable parts in the VE; means for causing data to be stored upon a change in a relative position of one of the plurality of movable parts of the physical object, wherein the data to be stored is associated with the change in the relative position of the one of the plurality of movable parts; means for transferring at least a portion of the stored data from the physical object to the VE using a portal having a platform which the physical object is placed on.

Example 115 may include the apparatus of example 114, further comprising means for transferring data from the VE to the portal having the platform on which the physical object is placed.

Example 116 may include the apparatus of example 114, wherein the physical object is a toys-to-life (TTL) object.

Example 117 may include the apparatus of example 114, wherein the data store is in a base of the physical object.

Example 118 may include the apparatus of example 114, further comprising means for changing a relative position of a first of the plurality of movable parts of the physical object by the portal platform when the physical object is placed on the portal platform or by a player when the physical object is placed on the portal platform or is not placed on the portal platform.

Example 119 may include the apparatus of example 118, wherein the relative change of position of the first of the plurality of moveable parts includes a removal of the first of the plurality of moveable parts from the physical object.

Example 120 may include the apparatus of example 118, wherein means for changing the relative position of the first of the plurality of movement of the plurality of moveable parts includes means for moving: one or more arms, one or more legs, a hand, a head, a mouth, a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or some other portion of the physical object.

Example 121 may include the apparatus of example 118, further comprising means for placing the physical object on the portal platform; and means for causing the first of the plurality of moveable parts of the physical object to change a relative position based upon an electric current or an electric field applied by the portal to an electro active polymer (EAP) included in the first of the plurality of moveable parts of the physical object or that is connected to the first of the plurality of moveable parts of the physical object.

Example 122 may include the apparatus of example 118, further comprising means for placing the physical object on the portal platform; and means for causing the portal to insert a rod into the physical object to implement a mechanical connection with the physical object, wherein manipulation of the rod is to cause the first of the plurality of moveable parts of the physical object to change a relative position.

Example 123 may include the apparatus of example 118 further comprising means for placing the physical object on the portal platform; and means for causing the portal to provide instructions to the physical object to cause the first of the plurality of moveable parts of the physical object to change a relative position.

Example 124 may include the apparatus of example 123, wherein to provide instructions further includes to provide instructions via Bluetooth, Bluetooth low energy (BLE), RFID, NFC, or electromagnetically.

Example 125 may include the apparatus of example 123, wherein the physical object further comprises: one or more sensors to receive the instructions from the portal apparatus; one or more motors or mechanisms to cause the first of the plurality of moveable parts of the physical object to change a relative position based upon the received instructions.

1. A portal apparatus for use with a virtual environment (VE), comprising:
a platform that includes an active area; and
a controller coupled with the active area to transfer data associated with a representation of a physical object in the VE, to the VE, after the physical object is directly physically and kinetically coupled to the active area, and receive commands from the VE with respect to the physical object;
wherein the controller is further to cause the physical object to move in-situ or around on the platform, in response to the commands received from the VE after the physical object has been directly physically and kinetically coupled to the active area.

2. The portal apparatus of claim 1, wherein the controller is to raise the platform, lower the platform, or tilt the platform at an angle.

3. The portal apparatus of claim 1, wherein the controller is to cause the physical object, when directly physically and kinetically coupled to the active area, to move up, to move down, to rotate clockwise, or to rotate counterclockwise based on an orientation of the apparatus.

4. The portal apparatus of claim 3, wherein the controller is further to cause motors, bands, gears, and/or electromagnets to move within the portal apparatus to facilitate movement of the physical object.

5. The portal apparatus of claim 1, wherein the controller is to cause the physical object, when directly physically and kinetically coupled to the active area, to move to a different location within the active area.

6. The portal apparatus of claim 1, wherein the controller is to raise, lower, or otherwise move a docking station with respect to the platform.

7. The portal apparatus of claim 6, wherein the docking station is to receive a smartphone or a tablet.

8. The portal apparatus of claim 7, wherein the smartphone or the tablet is further to couple with the controller and to cause one or more actions to be performed on behalf of the controller.

9. The portal apparatus of claim 1, wherein to cause a portion of the physical object to move in-situ further includes to move: one or more arms, one or more legs, a hand to cause it to change position, the position of a head, the position of a mouth, the extension of a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or other portion of the physical object.

10. A method for providing a portal for use with a virtual environment (VE), comprising:
providing an active area on a platform of a portal apparatus;
directly physically coupling a physical object to the active area;
transferring data associated with a representation of the physical object in the VE to the VE and/or receiving commands from the VE for the physical object; and
causing the physical object to move in-situ or around on the platform in response to the commands received from the VE.

11. The method of claim 10, further comprising raising the platform, lowering the platform, or tilting the platform at an angle.

12. The method of claim 10, further comprising causing the physical object, when placed on the active area, to move up, to move down, to rotate clockwise, or to rotate counterclockwise based on an orientation of the apparatus.

13. The method of claim 12, further comprising causing motors, bands, gears, and/or electromagnets to move within the portal apparatus to facilitate movement of the physical object.

14. The method of claim 10, further comprising causing the physical object, when directly physically coupled to the active area, to move to a different location within the active area.

15. A physical object to be used with a virtual environment (VE), comprising:
a plurality of movable parts;
a data store to store data associated with a representation of the physical object in the VE, wherein a change in a relative position of one of the plurality of movable parts triggers storage of data associated with the change in the relative position in the data store; and
a communication interface coupled to the data store to transfer at least a portion of the stored data from the physical object to the VE via a portal having a platform to which the physical object is placed on and directly physically coupled to.

16. The physical object of claim 15, wherein the communication interface is to transfer data from the VE to the portal having a platform which the physical object is directly physically coupled to.

17. The physical object of claim 15, wherein the physical object is a toys-to-life (TTL) object.

18. The physical object of claim 15, wherein the data store is in a base of the physical object.

19. The physical object of claim 15, wherein a first of the plurality of moveable parts of the physical object is to change a relative position by the portal platform when the physical object is directly physically coupled to the portal platform or by a player when the physical object is directly physically coupled to the portal platform or is not directly physically coupled to the portal platform.

20. The physical object of claim 15, wherein movement of a first of the plurality of moveable parts includes a removal of the first of the plurality of moveable parts from the physical object.

21. The physical object of claim 15, wherein the change of the relative position of a first of the plurality of movement of the plurality of moveable parts includes a movement of: one or more arms, one or more legs, a hand, a head, a mouth, a claw, a belly to cause it to expand or contract, muscles to cause them to grow or shrink; bumps on a skin to cause them to raise or lower, horns to cause them to extend or retract, a tongue to cause it to push out or pull in, eyes to cause them to move or to bulge, a weapon to cause it to raise, lower, thrust or withdraw, and/or some other portion of the physical object.

22. The physical object of claim 15, wherein the physical object is placed on the portal platform and directly physically coupled to the portal platform; and wherein the portal is to cause a first of the plurality of moveable parts of the physical object to change a relative position based upon an electric current or an electric field applied by the portal to an electro active polymer (EAP) included in the first of the plurality of moveable parts of the physical object or that is connected to the first of the plurality of moveable parts of the physical object.

23. A method to implement a physical object to be used with a virtual environment (VE), comprising:
storing data associated with a representation of the physical object having a plurality of movable parts in the VE;
causing data to be stored upon a change in a relative position of one of the plurality of movable parts of the physical object, wherein the data to be stored is associated with the change in the relative position of the one of the plurality of movable parts;
transferring at least a portion of the stored data from the physical object to the VE using a portal having a platform which the physical object is placed on and kinetically coupled to.

24. The method of claim 23, further comprising transferring data from the VE to the portal having the platform on which the physical object is placed and kinetically coupled to.

25. The method of claim 23, wherein the physical object is a toys-to-life (TTL) object.
